(19) United States
(12) Patent Application Publication
(10) Pub. No.: US 2013/0335272 A1
(43) Pub. Date: Dec. 19, 2013

(54) CALCULATING A LOCATION

(71) Applicants: Fabio Belloni, Espoo (FI); Ville Ranki, Jorvas (FI); Antti Kainulainen, Nummela (FI)

(72) Inventors: Fabio Belloni, Espoo (FI); Ville Ranki, Jorvas (FI); Antti Kainulainen, Nummela (FI)

(21) Appl. No.: 14/003,544

(22) PCT Filed: Mar. 8, 2011
(86) PCT No.: PCT/IB11/50971

§ 371 Date: Sep. 6, 2013

(51) Int. Cl. G01S 5/02

(52) U.S. Cl. CPC G01S 5/02
USPC 342/451

(57) ABSTRACT

Apparatus comprises one or more processors in communication with one or more memories. The one or memories have stored therein one or more computer programs that include computer code configured such as when executed to cause the processor to: receive data derived from a multi-element antenna direction finding arrangement; process the received data to provide elevation and azimuth vector data; determining whether the elevation data meets a reliability criterion. On a positive determination the elevation and azimuth data is used to calculate a location. On a negative determination, the data is processed to provide one-dimensional azimuth vector data; and the one-dimensional azimuth vector data is used in conjunction with other vector data to calculate a location.

### FIELD

This specification relates to calculating a location.

### BACKGROUND

There are a number of known techniques for determining the position of an apparatus using radio frequency signals. Some popular techniques relate to use of the Global Positioning System (GPS), in which multiple satellites orbiting Earth transmit radio frequency signals that enable a GPS receiver to determine its position. However, GPS is often not very effective in determining an accurate position indoors.

Systems have been proposed for allowing location determination indoors using multi-antenna arrays and a single receiver. Here, different elements of the array are connected to the receiver in turn by a switch. Samples of the signals thus provided are processed to determine a bearing from which the signal was received. Similarly, a receiver in a mobile device can receive a positioning signal from a fixed location multi-antenna array transmitter and determine therefrom a bearing to the mobile device from the transmitter. Such systems are disclosed in a number of patent documents filed by Nokia Corporation including WO 2009/56150, WO 2010/136064, WO 2009/066132, WO 2010/009763 and WO 2010/006651.

### SUMMARY

A first aspect of this specification provides a method comprising:
receiving data derived from a multi-element antenna direction finding arrangement;
processing the received data to provide elevation and azimuth vector data;
determining whether the elevation data meets a reliability criterion;
on a positive determination:
   using the elevation and azimuth data to calculate a location; and
on a negative determination:
   processing the data to provide one-dimensional azimuth vector data; and
   using the one-dimensional azimuth vector data in conjunction with other vector data to calculate a location.

The other vector data may be derived from a second multi-element antenna direction finding arrangement. Alternatively, the other vector data may be data previously derived from the first multi-element antenna direction finding arrangement.

Processing the data to provide one-dimensional azimuth vector data may comprise mapping a two-dimensional estimate to a one-dimensional estimate. Alternatively, processing the data to provide one-dimensional azimuth vector data may comprise summing data in each row of a two-dimensional data matrix. In the latter case, the method may comprise normalising the summed data.

The method may comprise mapping vector data to Cartesian data prior to calculating a location.

Determining whether the elevation data meets a reliability criterion may comprise comparing the elevation vector data to a threshold. The threshold may be set depending on the azimuth vector data corresponding to the elevation vector data.

Receiving data derived from a multi-element antenna direction finding arrangement may comprise receiving data derived from signals received at each of multiple elements of a multi-element antenna arrangement. Alternatively, receiving data derived from a multi-element antenna direction finding arrangement may comprise receiving data derived from signals transmitted by multiple elements of a multi-element antenna arrangement and received at a single element antenna arrangement. This specification also provides a computer program comprising machine readable code that when executed by computing apparatus controls it to perform the method above.

A second aspect of this specification provides apparatus comprising:
means for receiving data derived from a multi-element antenna direction finding arrangement;
means for processing the received data to provide elevation and azimuth vector data;
means for determining whether the elevation data meets a reliability criterion;
means responsive to a positive determination for:
   using the elevation and azimuth data to calculate a location; and
means responsive to a negative determination for:
   processing the data to provide one-dimensional azimuth vector data; and
   using the one-dimensional azimuth vector data in conjunction with other vector data to calculate a location.

A third aspect of this specification provides computer readable medium having stored thereon machine readable instructions that when executed control it to perform:

receiving data derived from a multi-element antenna direction finding arrangement;
processing the received data to provide elevation and azimuth vector data;
determining whether the elevation data meets a reliability criterion; on a positive determination:
   using the elevation and azimuth data to calculate a location; and on a negative determination:
   processing the data to provide one-dimensional azimuth vector data; and
   using the one-dimensional azimuth vector data in conjunction with other vector data to calculate a location.

A fourth aspect of this specification provides apparatus comprising:
one or more processors in communication with one or more memories, the one or memories having stored therein one or more computer programs that include computer code configured such as when executed to cause the processor to:
receive data derived from a multi-element antenna direction finding arrangement;
process the received data to provide elevation and azimuth vector data;
determining whether the elevation data meets a reliability criterion;
on a positive determination:
   use the elevation and azimuth data to calculate a location; and
on a negative determination:
   process the data to provide one-dimensional azimuth vector data; and
   use the one-dimensional azimuth vector data in conjunction with other vector data to calculate a location.

### BRIEF DESCRIPTION OF THE DRAWINGS

For a better understanding of various embodiments reference will now be made by way of example only to the accompanying drawings in which:

FIG. 1 illustrates a base station apparatus according to aspects of embodiments receiving radio signals from a transmitter according to other aspects of the embodiments;

FIG. 2 illustrates geometry of the FIG. 1 scenario;

FIG. 3 schematically illustrates one example of part of a base station of FIG. 1;

FIG. 4 illustrates a beacon message as transmitted by a mobile station of FIG. 1;

FIG. 5 is a block diagram illustrating one possible form for the base station of FIG. 3;

FIG. 6 is a schematic diagram illustrating a system including base stations and mobile devices;

FIG. 7 illustrates a general method for estimating the position of a mobile device.

FIG. 8 is a flow chart illustrating an enhanced method for estimating the position of a mobile device;

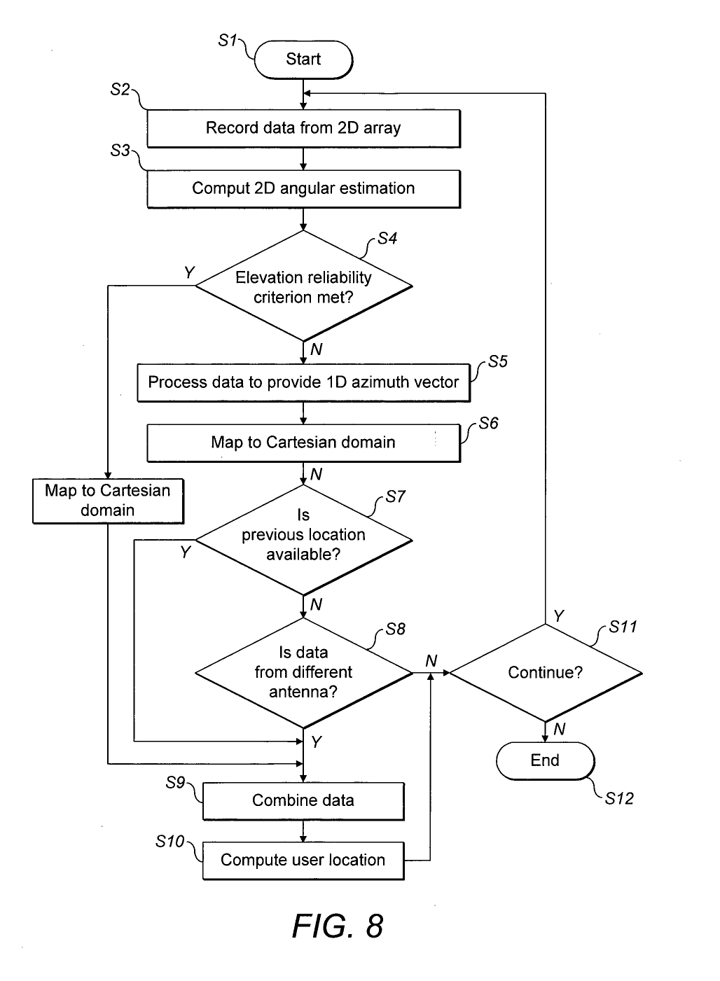

FIG. 9 shows matrices and illustrates conversion by the base station of FIG. 3 from two dimensions to one dimension; and

FIGS. 10 and 11 are schematic diagrams illustrating the results of conversion from 2D to 1D as is achieved by the FIG. 3 base station.

### DETAILED DESCRIPTION OF EMBODIMENTS

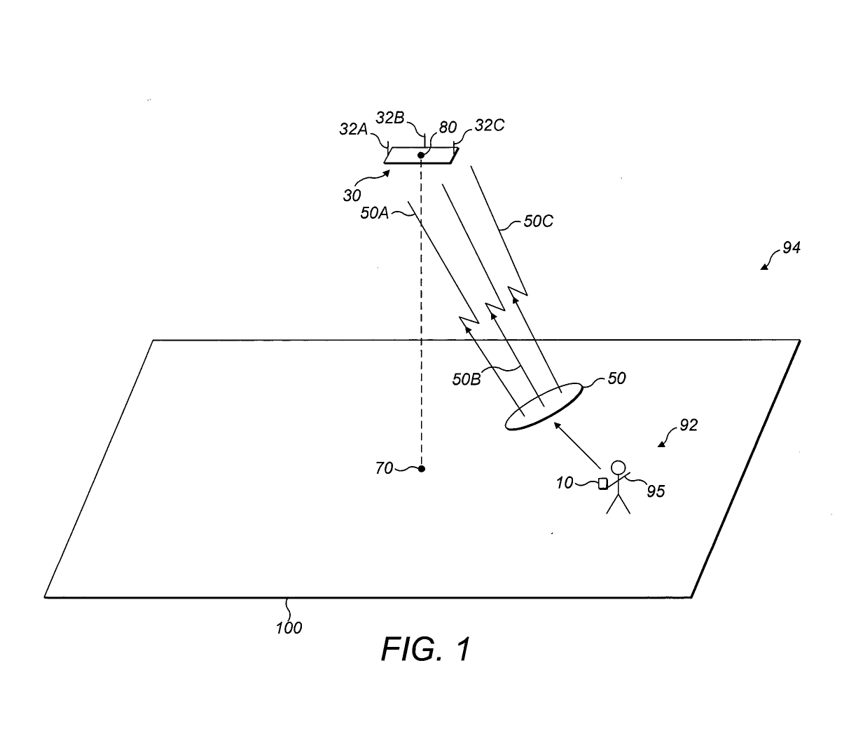

FIG. 1 illustrates a person 92 (carrying a mobile radio communications apparatus 10) at a position 95 on a floor 100 of a building 94. The building 94 could be, for example, a shopping centre or a conference centre. The mobile radio communications apparatus 10 is hereafter referred to as a mobile device. The mobile device 10 includes radio transmitter functionality and so can be called a transmitter. The mobile device 10 is operable to transmit radio signals that are receivable by the base station 30, for instance Bluetooth Low Energy (BT LE) protocol signals.

A base station receiver apparatus 30 is positioned at a location 80 of the building 94. In the illustrated example, the location 80 is on the ceiling of the building 94 (i.e. the overhead interior surface) but in other implementations the receiver may be placed elsewhere, such as on a wall or within an under-floor cavity. For reasons that will become apparent, the base station receiver apparatus 30 can be termed a positioning device or positioning receiver.

The location 80 is directly above the point denoted with the reference numeral 70 on the floor 100 of the building. The base station 30 is for enabling the position of the mobile device 10 to be determined, although that is not necessarily the only function provided by the base station 30. For example, the base station 30 may be part of a transceiver for providing wireless internet access to users of apparatuses 10, for example, via wireless local area network (WLAN) or Bluetooth Low Energy radio signals.

Briefly, the mobile device 10 transmits signals which are received at the base station 30. The base station 30 takes I and Q samples of the received signals. These I and Q samples are processed to determine a bearing of the mobile device 10 from the base station 30. From the bearing, the location of the mobile device 10 may be calculated. Calculation of the bearing from the I and Q samples, or alternatively from part-processed I and Q samples, may be performed by the base station 30, or externally to the base station. If bearing calculation is performed externally to the base station 30, I and Q samples or part-processed samples of the received signals are sent from the base station 30 to a server (not shown).

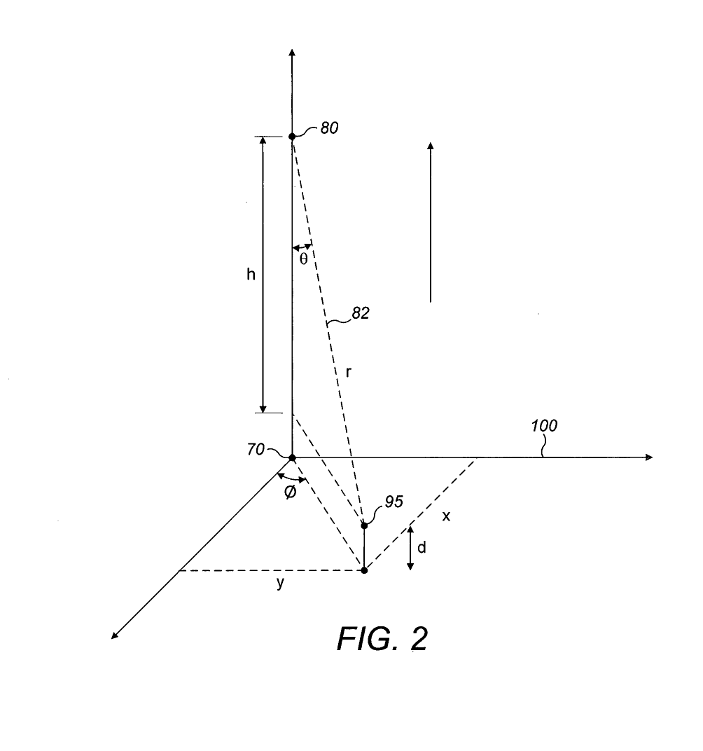

The position 95 of the person 92 is defined by specifying a position along a bearing 82 (illustrated in FIG. 2) which runs from the location 80 of the base station 30 through the location 95 of the mobile device 10. The bearing 82 is defined by an elevation angle θ and an azimuth angle cp.

The mobile device 10 may, for example, be a hand portable electronic device such as a mobile radiotelephone. The mobile device 10 may or may not include a positioning receiver such as a GPS receiver. The mobile device 10 may be a relatively simple device having limited functionality, such as a mobile tag. Here, the mobile tag 10 may be absent of a receiver. A mobile tag is absent of voice communication capability, and may also be absent of a display and audio transducers.

The mobile device 10 may transmit radio signals 50 periodically as beacons. The radio signals may, for example, have a transmission range of 100 meters or less. For example, the radio signals may be 802.11 wireless local area network (WLAN) signals, Bluetooth signals, Ultra wideband (UWB) signals or Zigbee signals. In the following embodiments, the radio signals preferably are signals transmitted according to the Bluetooth Low Energy protocol.

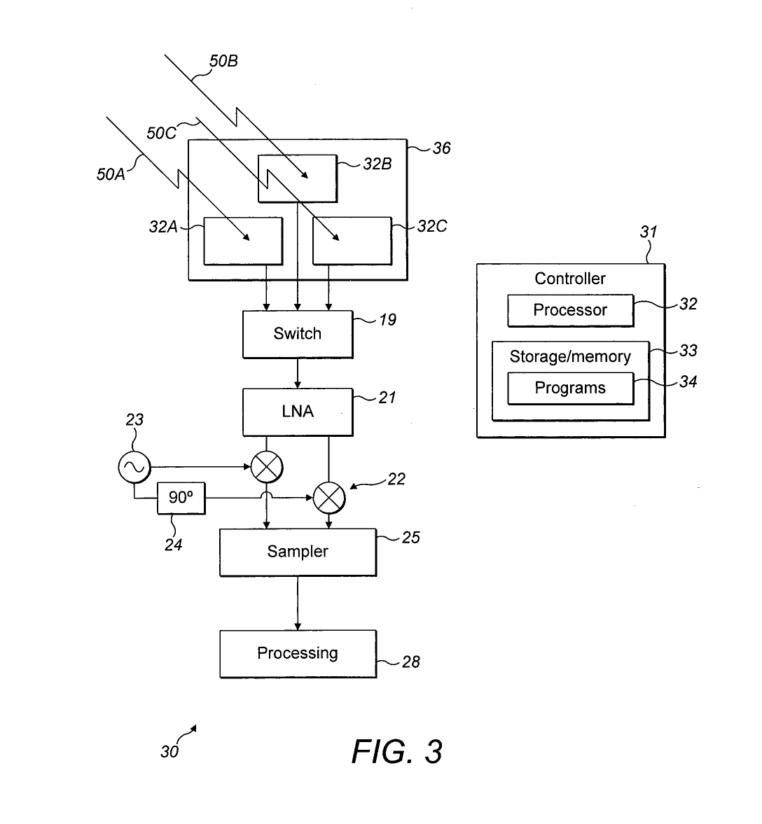

FIG. 3 schematically illustrates one example of part of the base station 30. The base station 30 comprises an antenna array 36 comprising a plurality of antenna elements 32A, 32B, 32C which receive respective radio signals 50A, 50B, 50C transmitted from the mobile device 10. Although three antenna elements 32 are shown, three is the minimum and the embodiments described here may include more, for instance 16 elements. In embodiments described below, 10 elements are present.

Each of the plurality of antenna elements 32A, 32B, 32C is connected to an switch 19, which is controllable by a controller 31 as described below. The switch 19 is controlled so that only one of the antenna elements 32A, 32B, 32C is connected to an amplifier 21 at a given time. The outputs of the amplifier 21 are received at a mixer arrangement 22. This is provided with in-phase (I) and quadrature (Q) signals by an arrangement of a local oscillator 23, which may be analogue or digital, and a 90° phase shifter 24. A sampler 25 is configured to receive I and Q output signals from the mixer arrangement and take digital samples thereof. The sampler 25 may take any suitable form, for instance including two digital to analogue converter (DAC) channels, one for the I channel and one for the Q channel. The effect of the mixer arrangement 24 and the sampler 25 is to downconvert the received signals and to provide digital I and Q samples of the downmixed signals.

An output of the sampler 25 is provided to a processing module 28.

A controller 31 is configured to control the other components of the base station apparatus 30. The controller may take any suitable form. For instance, it may comprise processing circuitry 32, including one or more processors, and a storage device 33, comprising a single memory unit or a plurality of memory units. The storage device 33 may store computer program instructions 34 that, when loaded into processing circuitry 32, control the operation of the base station 30. The computer program instructions 34 may provide the logic and routines that enables the apparatus to perform the functionality described above. The processing module 28 may be comprised solely of the controller 31. The computer program instructions 34 may arrive at the base station apparatus 30 via an electromagnetic carrier signal or be copied from a physical entity 21 such as a computer program product, a memory device or a record medium such as a CD-ROM or DVD.

The processing circuitry 32 may be any type of processing circuitry. For example, the processing circuitry 32 may be a programmable processor that interprets computer program instructions 34 and processes data. The processing circuitry 32 may include plural programmable processors. Alternatively, the processing circuitry 32 may be, for example, programmable hardware with embedded firmware. The processing circuitry 32 may be a single integrated circuit or a set of integrated circuits (i.e. a chipset). The processing circuitry 32 may also be a hardwired, application-specific integrated circuit (ASIC). The processing circuitry may be termed processing means.

The processing circuitry 32 is connected to write to and read from the storage device 33. The storage device 33 may be a single memory unit or a plurality of memory units.

The controller 31 operates to control the switch 19 to connect the antenna elements 32A, 32B, 32C to the amplifier 21 in turn. The controller 31 controls the switch 19 to connect one of the antenna elements 32A, 32B, 32C to the amplifier for the duration of transmission of the header of a packet transmitted by the mobile device 10. After the header has been received, the controller 31 controls the switch 19 to connect different one of the antenna elements 32A, 32B, 32C to the LNA 21 in a sequence. The interval between successive switching of the switch 19 can be equal to the symbol rate used in the payload of the transmitted packets or substantially equal to an integer multiple of the symbol rate.

In a prototype system constructed by the inventors, sixteen antenna elements 32A are used. In this system, each antenna element is sampled twice although one antenna element (a reference element) is sampled more frequently. Performing three measurements results in 104 samples which, with one byte for each I and Q sample, totals 208 bytes of data. These bytes are included in the message.

The I and Q samples constitute complex signal parameters in that the I and Q samples together define parameters of a complex signal.

Instead of processing ‘raw’ I and Q samples, the controller 31 may process the I and Q samples to provide other complex signal parameters relating to the received signals, from which bearing calculation can be performed. For instance, the controller 31 may provide averaging of the I and Q samples in the angle/phase domain before converting the averages back to the I and Q domain (one sample for each antenna) and providing the averaged samples as complex signal parameters. Alternatively, the controller 31 may calculate amplitude and/or phase information from the I and Q samples, and provide the amplitude, phase or phase and amplitude information as complex signal parameters.

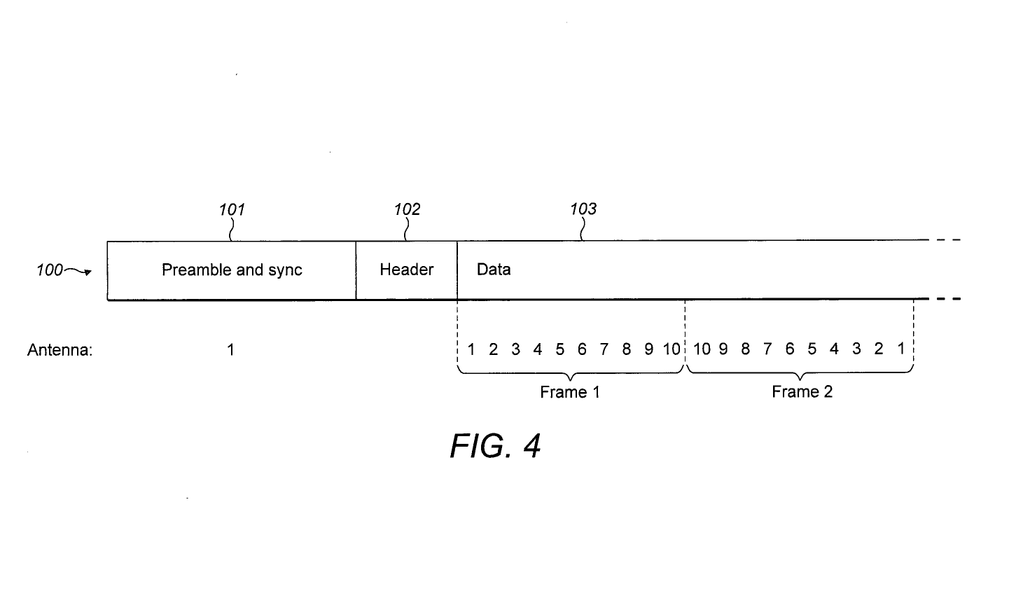

FIG. 4 illustrates a beacon message or positioning packet as transmitted by the mobile station 10, and shows switching between antenna elements in the base station 30 when receiving a positioning packet from the mobile device 10. The beacon message 100 comprises three key sections, namely a preamble and sync section 101, a header 102 and a data section 103. The purpose of the preamble and sync section 101 is to allow a receiver to synchronise itself with the transmissions. To this end, the preamble and sync section 101 may include alternating zeros and ones. The header 102 includes various information, including information identifying the mobile device 10. The header 102 may also indicate a transmit power of the mobile device 10.

The data section 103 does not include any information content. The purpose of the data section 103 is to enable a receiver, such as the base station 30, to be able to calculate a bearing to the mobile device from the receiver. In this example, the data comprises a sequence of ones. The data is notionally formed into a number of frames, two of which are shown at frame 1 and frame 2 in the figure. When receiving the data section 103, the base station 30 switches between different ones of the antenna elements. However, when receiving the preamble and sync section 101 and the header 102, switching is disabled so that only one of the antenna elements is connected to the receiver. In this example, it is the first antenna element that is connected to the receiver when the preamble and sync and header sections 101, 102 are being received.

Shown beneath the beacon signal 100 is an indication of the antenna element of the base station 30 that is connected to the receiver circuitry at a time corresponding to a part of the beacon 100. As shown, a first antenna element, for instance the antenna element 32A of FIG. 3, is connected to the receiver circuitry for the duration of transmission of the preamble and sync and header sections 101, 102 and for the first one-tenth of the frame 1 of the data section 103. The controller 31 controls the switch such that the antenna elements are connected to the receiver in turn. Each of ten antenna elements is connected in sequence to the receiver circuitry for equal periods of time in the first frame, in the sequence 1 . . . 10. This is shown in the section marked “frame 1” in the Figure, in which it can be seen that the controller 31 causes to be connected to receiver firstly the first antenna element, then the second antenna element, and so on up to the tenth antenna element.

At the end of the first frame, a second frame, labelled “frame 2” in the Figure, commences. In the second frame, the controller operates the switch so as to reverse the sequence of connection of antenna elements to the receiver. In particular, the controller causes the tenth antenna element to be connected to the receiver, followed by the ninth, the eight and so on until the first antenna element is connected to the receiver. The interval between successive switching is the same for each of the antenna elements, and is the same in the second frame as it is in the first frame. As such, the length of the second frame is the same as that of the first frame. The switching interval is dependent on the hardware of the receiver, in particular the RF switch and filters.

This switching sequence is merely illustrative and any suitable switching sequence may be used instead.

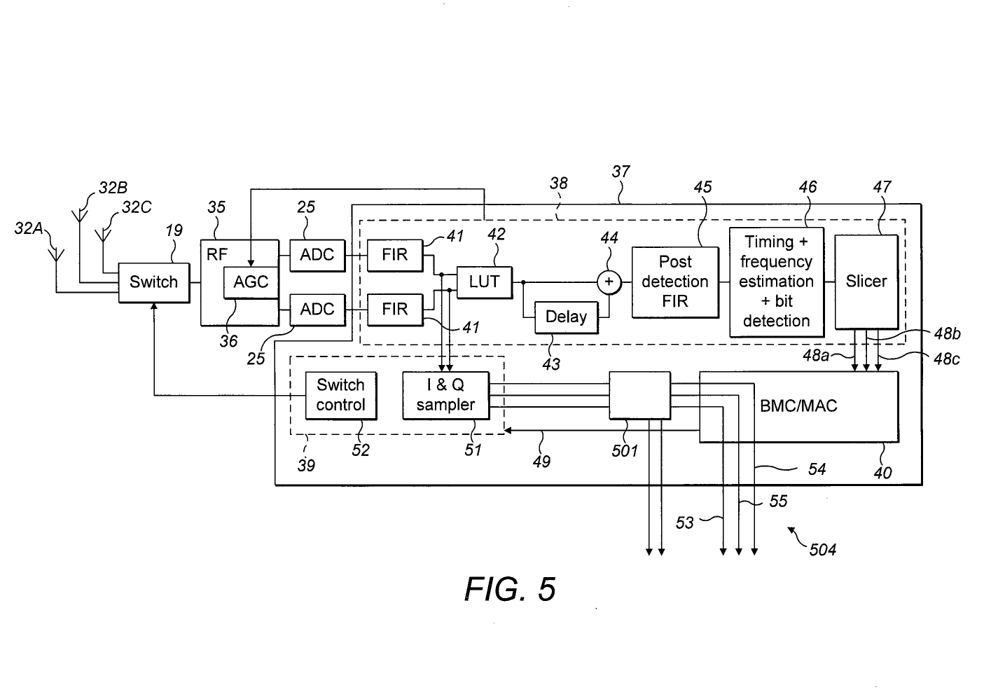

FIG. 5 is a block diagram illustrating one possible form for the base station 30, including some detail of the processing module 28. Reference numerals are retained from FIG. 3 for like elements.

At the output of the switch 19, an RF module 535 is connected. The RF module 535 includes an automatic gain control (AGC) part 536, which has a gain control input. The sampler 25, in the form of two analogue to digital converters, is connected to outputs of the RF module 535. The components thusfar described are implemented in hardware, and all of the other components shown in FIG. 5 are implemented on a field programmable gate array (FPGA) 537. The FPGA 537 includes 3 main blocks, namely a Bluetooth low energy receiver base band (BT LE BB) module 538, an antenna switching and I and Q sampling module 539 and a burst mode controller/media access controller (BMC/MAC) module 540. The control input of the AGC 536 is provided by the BT LE BB module 538.

Outputs of the sampler 25 are connected to 2 parallel finite impulse response (FIR) filters 541. Outputs of the FIR filters 541 are connected to inputs of a look up table (LUT) 542. An output of the LUT 542 is connected both to an input of a delay element 543 and to an input of a summer 544. The other input of the summer 544 is connected to the output of the delay element 543. An output of the summer 544 is connected to a post detection FIR filter 545. A timing and frequency estimation and bit detection module 546 is connected to an output of the post detection FIR filter 545. A slicer 547 is connected to an output of the timing and frequency estimation and bit detection module 546 and receives information bits therefrom.

The slicer provides three outputs to the BMC/MAC module 540. A first 548a carries a preamble found signal. A second 548b carries a sync found signal and a third 548c carries information bits.

A first output of the BMC/MAC module 540 is connected to an antenna switching on/off input of the antenna switching module 19.

The antenna switching and I and Q sampling module 539 includes an I and Q sampler 551 and a switch controller 552. The I and Q sampler has inputs connected to the outputs of the FIR filters 541. The I and Q sampler 551 provides 8 byte samples of I and Q signals respectively on first and second outputs 553, 554. The I and Q sampler 551 provides an AGC output 555. The three outputs of the I and Q sampler 551 are connected to inputs of the BMC/MAC 540.

The BMC/MAC module 540 is operable to detect the format of received packets, and to ensure that correct packets are processed. The BMC/MAC module 540 is configured to disregard non-positioning packets. The BMC/MAC module 540 is also configured to cause antenna switching and I and Q sampling to be performed at the appropriate times during reception of a positioning packet.

The MAC part of the BMC/MAC module 540 also constructs the message/packets that include the complex signal parameters, e.g. the I and Q samples. The BMC/MAC module 540 also performs interference detection, as described above.

The switch controller 552 has an output that is connected to a control input of the switch 19. The output of the switch controller 552 thus controls which of the multiple antenna elements 32A-32C are connected to the RF module 535 at a given time. Depending on the signal provided on the output 549 of the BMC/MAC 540, the antenna switching module 539 is controlled either to switch between antenna elements 32A-32C in a desired sequence, or to connect only one of the antenna elements to the RF module 535.

The base station 30 includes either a carrier frequency offset calculator and compensator 501 before the BMC/MAC 540, although it may instead be located after the BMC/MAC 540.

The base station 30, in particular the processing module 28, is configured to use parameters of complex signals received from the sampler 25 to calculate a bearing to the mobile device 10 from the base station 30. Alternatively, the calculation of a bearing to the mobile device may be performed by another device using information provided by the base station 30. The device that performs the calculation of the bearing may for instance be a mobile device, a server, or a network component.

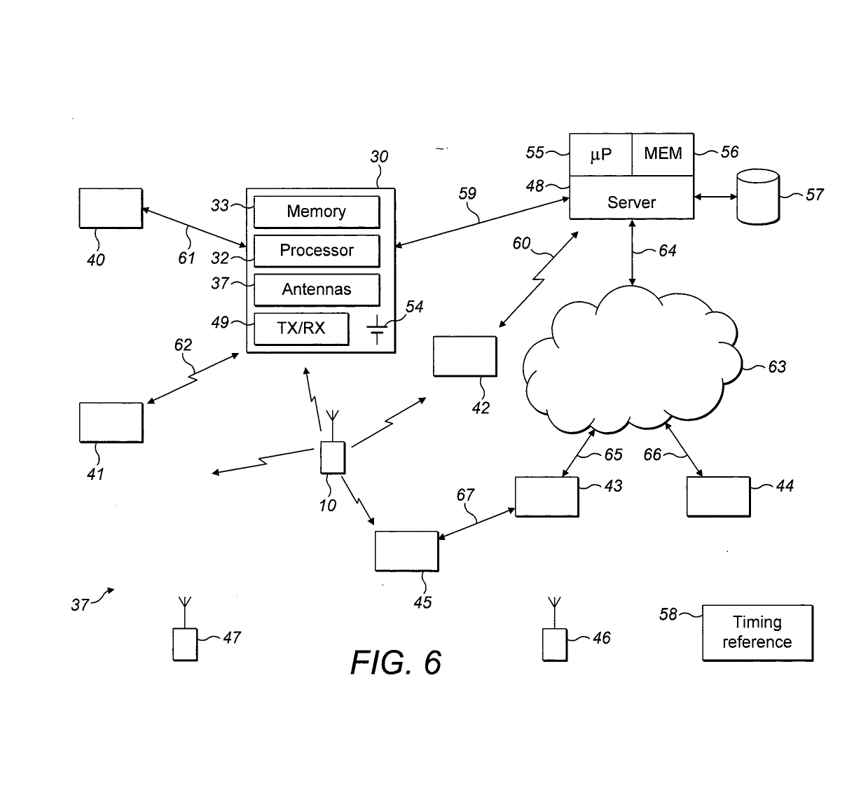

FIG. 6 is a schematic diagram illustrating a system 37 including the base station 30 and the mobile device 10. The base station 30 is a first base station in a plurality of base stations, second to seventh ones of which are labelled at 40 to 45 respectively. The mobile device 10 is a first mobile device amongst a plurality of devices, second and third ones of which are illustrated at 46 and 47 respectively. A server 48 is connected either directly or indirectly to each of the plural base stations 30, 40 to 45.

The first to seventh base stations 30, 40 to 45 are provided at various locations around a zone of interest. The zone of interest may, for example, be an office building or a shopping centre, as discussed above. The distribution of the base stations around the zone of interest allows the locations of mobile devices 10, 46, 47 within the zone of interest to be determined.

The first to seventh base stations 30, 40 to 45 are the same as one another, unless otherwise stated. Some components of the first base station 30 are shown in FIG. 6, and it will be appreciated that these are included also in the other base stations but are omitted from the Figure for the sake of clarity. The first base station 30 is shown as including antennas 38, a transmitter/receiver interface 49, one or more memories 33 and one or more processors 32. The first base station 30 also includes a power supply 54, which is shown as a battery in FIG. 6, although it may alternatively be a connection to a mains power supply for instance.

The server 48 constitutes computing apparatus. The server 48 includes one or more processors 55 and one or more memories 56. The server 48 also is connected to a database 57, which may be internal to the server 48 or may be external. The server 48 is so-called because it has processing resources that exceed the resources of other components of the system 37 by a significant degree.

The system 37 also includes a timing reference 58, which may take any suitable form. The timing reference 58 provides a source of reference time to various components of the system 37, including the base stations 30, 40 to 45 and the server 48. The timing reference 58 may also provide reference time to the mobile devices 10, 46, 47.

FIG. 6 illustrates alternative ways in which the plurality of base stations may be connected to the server 48. Some base stations may be connected directly to the server by wired links, for instance Ethernet links. The first base station 30 is shown as being connected directly to the server 48 by a first wired link 59. Other ones of the plurality of base stations 42 are connected directly to the server 48 by wireless links. The fourth base station 42 is shown as connected to the server 48 by a first wireless link 60. Other base stations are connected to the server 48 by an intermediary base station or by an intermediary network 63. The network may be an Internet Protocol (IP) network, for instance the Internet or an intranet. The connection of the server 48 to the fifth to seventh base stations 43 to 45 via the network 63 allows the server 48 to be located remote from the base stations. For instance, the server 48 could be located at premises of a positioning service provider, and may be in a different country or even on a different continent to the base stations 43 to 45. Packets are able to be passed between the server 48 and the fifth to seventh base stations 43 to 45 by way of routing enabled by destination address information included in packet headers.

Since the first to seventh base stations 30, 40 to 45 are located in the same zone of interest, a mobile device, such as the first mobile device 10, may be within range of a number of the base stations. In FIG. 6, transmissions of the first mobile device 10 are illustrated to be receivable by the first, third, fourth and seventh base stations 30, 41, 42 and 45.

FIG. 6 illustrates a method for estimating the position of the apparatus 10.

The respective spatially diverse received radio signals 50A, 50B, 50C are received at the base station receiver apparatus 30 as illustrated in FIGS. 1 and 2. At block 200 of the method of FIG. 6, the base station 30 provides I and Q samples of first, second and third radio signals 50A, 50B, 50C incident on the base station 30.

At block 210, the processing module 28 uses the I and Q samples to estimate a bearing 82 of the apparatus 10 from location 80 of the base station receiver apparatus 30. One method of determining the bearing 82 is now described, but other methods are possible.

Once complex samples from each antenna element 32 are obtained, the array output vector y(n) (also called a snapshot) can be formed at by the processing module 28:

y(n)=[x₁,x₂, . . . ,x_{M}] (1)

Where xᵢ is the complex signal received from the ith antenna element 32, n is the index of the measurement and M is the number of elements 32 in the array 36.

An Angle of Arrival (AoA) can be estimated from the measured snapshots if the complex array transfer function a(φ,θ) of the RX array 36 is known, which it is from calibration data.

The simplest way to estimate putative AoAs is to use beamforming, i.e. calculate received power related to all possible AoAs. The well known formula for the conventional beamformer is

P_{BF}(φ,θ)=a*(φ,θ)\check{R}a(φ,θ) (2)

### Where,

$${R}^{⋁} = \frac{1}{N} {\sum }_{n = 1}^{N} y ( n ) {y}^{*} ( n )$$

is the sample estimate of the covariance matrix of the received signals, a(φ,θ) is the array transfer function related to the DoD(φ,θ) φ is the azimuth angle and θ is the elevation angle.

Once the output power of the beamformer P_{BF}(φ,θ) is calculated in all possible AoAs, the combination of azimuth and elevation angles with the highest output power is selected to be the bearing 82.

Next, at block 220 the processing module 28 estimates a position of the apparatus 10. This may involve the processing module 28 estimating a position of the apparatus using the bearing and constraint information. The use of constraint information enables the processing module 28 to determine the location of the apparatus 10 along the estimated bearing 82.

FIG. 2 also illustrates the bearing 82 from the location 80 of the receiver apparatus 30 to the location 95 of the transmitter apparatus 10, which has been estimated by the processing module 28 following reception of the radio signals 50. The bearing 82 is defined by an elevation angle θ and an azimuth angle φ

The processing module 28 may estimate the position of the apparatus 10 relative to the location 80 of the receiver apparatus 30 in coordinates using the bearing (elevation angle θ and azimuth angle φ) and constraint information e.g. vertical displacement h or an additional bearing or a range r. The processing module 28 may estimate the position of the apparatus 10 in Cartesian coordinates by converting the coordinates using trigonometric functions.

Using information identifying the location and orientation of the base station 30, the processing module 28 can calculate the absolute location of the mobile device 10 from the bearing and the constraint information.

Alternatively, block 220 may involve triangulating from two base stations 30. In this case, constraint information is not required, although the use of constraint information is not precluded. In this alternative, block 200 involves processing bearings relating to the mobile device 10 provided by two base stations 30. Block 210 is performed for each of the base stations, providing two bearings. Block 220 involves the processing module 28 using information identifying the location and orientation of both of the base stations 30 and the bearings therefrom to calculate the absolute location of the mobile device 10 through triangulation.

As mentioned above, the bearing calculation and positioning of steps 210 and 220 can be performed at any suitable apparatus. Indeed, the bearing calculation may be performed at a different apparatus to the apparatus that performs the positioning calculations. This is the case even when bearing information from only one base station is used. In the case of triangulating from two or more bases stations, though, the base stations may calculate bearing information and one of the base stations may calculate position.

When apparatus other that the base station 30 that received the positioning signal from the mobile device 10 calculated the position of the mobile device, the information identifying the location and orientation of the base station 30 may be received at the apparatus in any suitable way. For instance, it may be broadcast directly by the base station 30. Broadcast may occur periodically, or the information may be broadcast along with or as part of a message that carries I and Q samples or bearing information. Alternatively, the information identifying the location and orientation of the base station 30 may be obtained by the apparatus by accessing a database, for instance using a browser application or using another query and response technique.

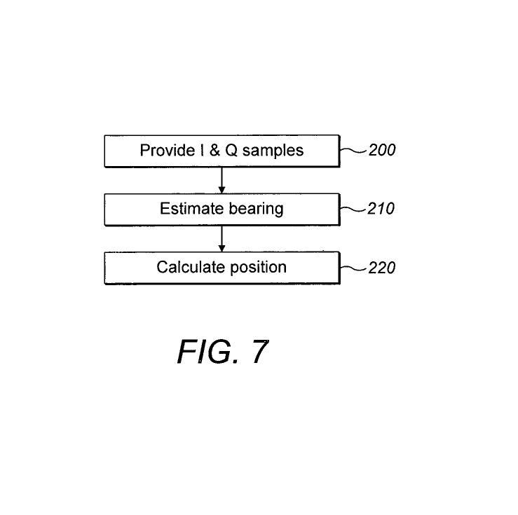

The inventors have invented a way to improve position calculation from the scheme described above, which will now be described with reference to the flowchart of FIG. 7.

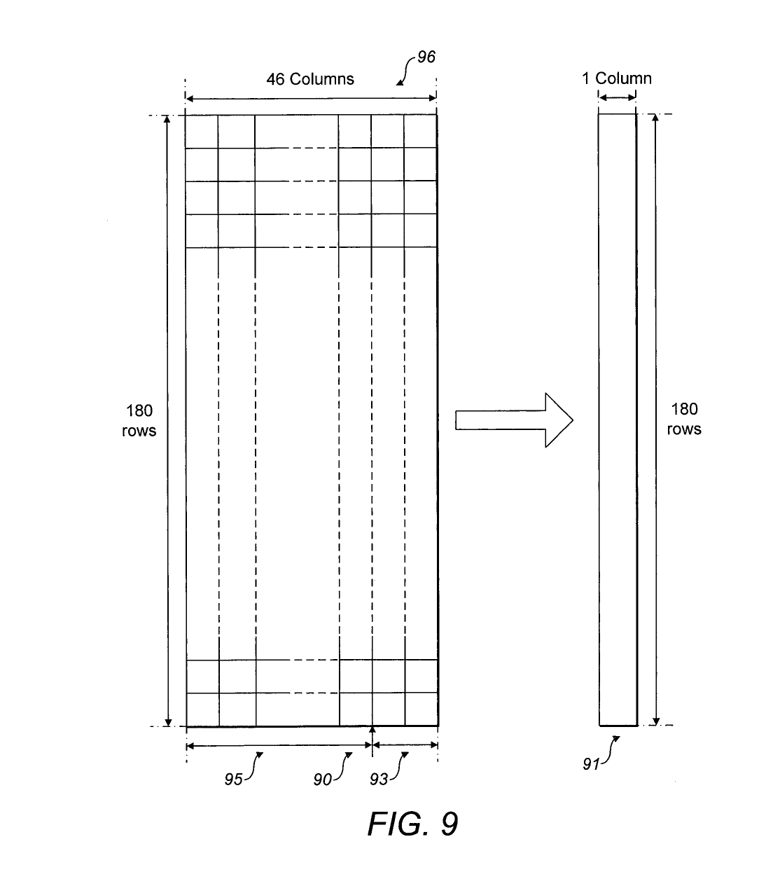

The operation starts at step S1. At step S2, data is recorded from the antenna array 32. At step S3, the two-dimensional angular estimation is computed. This can be performed in any suitable way, for instance as described above in relation to block 210 of FIG. 6. Step S3 provides elevation and azimuth vector data, indicating an estimated elevation and azimuth bearing respectively to the mobile device 10 from which the corresponding signal was received. The data may be provided as a two-dimensional matrix having azimuth angles in one dimension and elevation angles in the other dimension, as is described below with reference to FIG. 9. Such can be said to provide a two dimensional representation of the likelihood of the mobile terminal being at a position on a sphere.

At step S4, it is determined whether a reliability criterion relating to the elevation vector computed in step S3 is met. The reliability criterion may take one of a number of forms. In its simplest form, the criterion may simply involve a determination as to whether the angular vector exceeds a threshold. If the threshold is not exceeded, the criterion can be said to have been met, and if the threshold is exceeded, the criterion can be said not to have been met. In this simple embodiment, a relatively high value of the elevation vector is assumed to give rise to a low reliability, in the sense that higher elevations give rise to lower accuracy of elevation vector calculation. The threshold may be set dependent on the hardware configuration. The threshold may be different for different hardware configurations, particularly where the configurations give rise to different antenna characteristics.

If the criterion is not met in step S4, at step S5 the data is processed to provide a one-dimensional azimuth vector. This can happen in a number of different ways, and can depend on the nature of the two-dimensional data.

Following step S5, the one-dimensional azimuth vector is mapped to the Cartesian domain at step S6.

Following step S6, it is determined at step S7 whether data relating to a location of the mobile device 10 at an earlier time is available. This step may be limited to locations determined within a pre-determined time interval, for instance 10 seconds, a few tens of second or 1 minute. Alternatively, this step may be limited to locations determined from a predetermined preceding number of positioning signal transmissions of the mobile device 10. For instance, only locations determined from the two immediately preceding positioning signals may be used.

In the event of a negative determination at step S7, it is determined at step S8 whether information about the location of the mobile device 10 from an antenna arrangement that is different to the antenna arrangement 32, i.e. from another base station 30 is available. This step may exclude information that is too old to be useful, for instance information that was derived from a measurement performed at a time that is separated from the current time by an amount that exceeds a threshold. The times may be determined from timestamps that are stored with previous data and with a current time. On a positive determination, or following a positive determination at step S7, at step S9 the data relating to the mobile device 10 is combined. This involves combining the data recorded at step S1 with earlier data relating to the same mobile device 10.

At step S10, the location of the mobile device 10 is computed from the data provided by step S9. The location is then stored in memory with a timestamp indicating the time to which the location relates. Following step S10, operation proceeds to determine at step S11 whether or not it is required to continue. On a positive determination, the operation proceeds again to step S2. Otherwise, the operation ends at step S12. Step S11 is performed also in the event of a negative determination at step S8.

If at step S4 the reliability criterion is determined to have been met, at step S13 the azimuth and elevation vectors are mapped to the Cartesian domain in two dimensions. This is similar to step S6 although, as mentioned above, step S6 is only in one dimension.

Following step S13, the location of the mobile device 10 is computed at step S10, after combining with any other relevant data at step S9. It can be advantageous to use information provided by multiple base stations in step S10 even if the reliability criterion is determined to have been met at step S4. In fact, the more relevant information is used, the more accurate and reliable is the result that is computed in step S10.

It will be appreciated that step S10 can be performed using information from only one base station 30 in the event of the reliability criterion having been determined to be met at step S4, whereas if the criterion is not met, then step S10 may require using data from two base stations 30. However, this is not necessarily the case. For instance, in the event of a positive determination at step S7, the previous user location determination and the azimuth vector provided by step S5 are used to provide a location of improved accuracy and reliability. In this case, the azimuth vector provided by step S5 can be used to improve the accuracy and/or reliability of the previous location result even though elevation information is not included in the data provided by step S5. The provision of the azimuth vector only will be appreciated to contribute to maximising the use of relevant reliable information whilst having regard to physical limitations of the system. The use of the azimuth only information compares favourably with the alternative of disregarding bearing information that originates from a potentially unreliable measurement.

One example scheme for processing the data to provide a one-dimensional azimuth vector in step S5 will now be described with reference to FIG. 9. Here, a two-dimensional estimation is mapped into a one-dimensional estimation. For instance, with a matrix 90 of size 180×46 (with 180 rows of azimuth data and 46 columns of elevation data), step S5 may involve mapping this data into a vector matrix 91 of size 180×1. This data mapping may be achieved simply by summing the estimated values for each row of azimuth data. After summation, the resulting vector may be normalised. Normalising results in preservation of the total power. This technique for mapping the 2D data into 1D is relatively simple to implement. Furthermore, it has an additional advantage in that it preserves multipath information in that two or more peaks may be present in the resulting vector. The preserved multipath information may be used in assessing the reliability of the estimation of the azimuth vector.

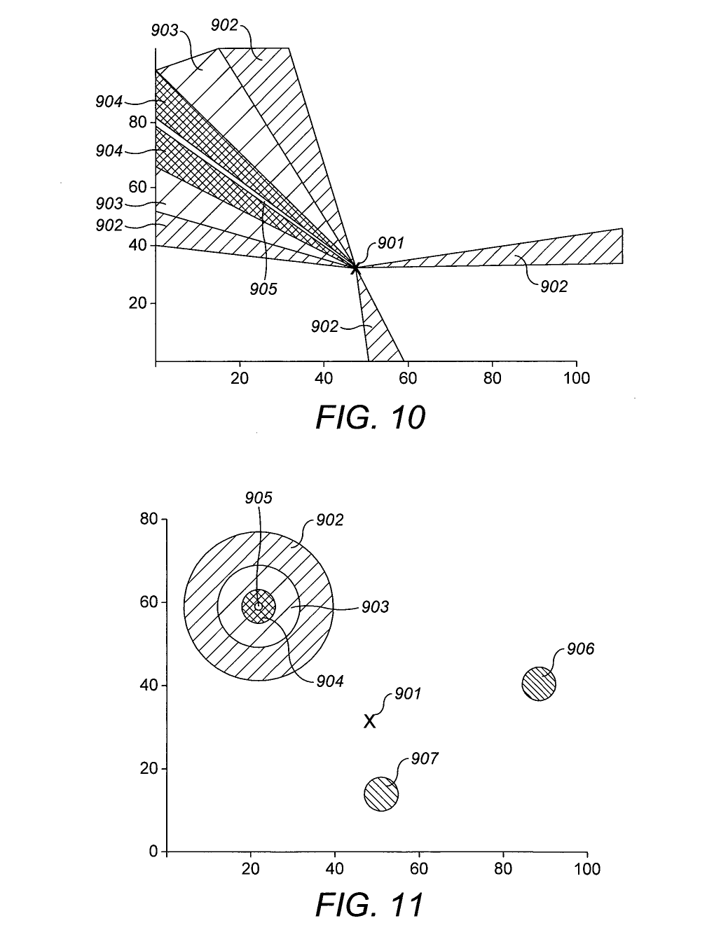

Results of such mapping are illustrated in FIGS. 10 and 11. Here, a base station location 901 is represented in Cartesian coordinates, with distances in metres on the x and y axes. In FIG. 10, a probability density function (pdf) illustrates the likelihood of a mobile device 10 being located at different locations. A first area 902 represents a lowest likelihood, with second third and fourth areas 903, 904, 905 respectively representing increasing likelihoods. Higher likelihood areas are contained wholly within the boundaries of lower likelihood areas. Fifth and sixth areas 906, 907 of low likelihood are located externally to the first area. These are provided by weak multipath signals. The likelihood of the mobile device being located along an elevation bearing is determined by the processing module 28. After mapping to one-dimensional coordinates, a resulting pdf is as shown in FIG. 11. Here, it can be seen that only azimuth bearing information remains. The weak multipath signals also can be seen in the bottom right quadrant relative to the base station location 901.

A first alternative scheme for processing the data to provide a one-dimensional azimuth vector in step S5 will now be described, again with reference to FIG. 9. Here, a matrix 90 of size 180×46 is provided in the same way as described above. Step S5 involves mapping this data into a matrix vector 91 of size 180×1. Mapping occurs by summing the estimated values for each row of azimuth data, but disregarding the values that are in columns that correspond to values below the threshold used in step S4. For instance, if the threshold is 70 degrees, data in a row that it in the columns relating to elevation angles between 70 degrees and 90 degrees are summed and provided in the resulting matrix 91. In the FIG. 9 example with 46 columns, this equates to 70*(46/90)=the 36th column to the last column. These columns are indicated at 93 in the Figure. Columns in which the data is disregarded are indicated at 95.

This approach has an advantage in that it can result in signal reflections that are incident at low reflection angles being omitted from the resulting one dimensional vector. Also, this can require fewer computational resources than the scheme described above, thus allowing conversion to be completed in less time.

In a second alternative, only the data in the column corresponding to the estimated elevation direction. For instance, if the elevation angle is estimated at 83 degrees, data from a column 96 corresponding to 83 degrees is placed in to the resulting matrix 91. This further simplifies the process. However, the results are more likely to provide an erroneous reading.

Instead of representing the 2D angular information in a matrix format, as shown in FIG. 9, the information may be represented in a vector. With data having the same resolution as above, the vector is of size 1×(180*46) instead of a matrix of size 180×46. Here, the 1×(180*46) size vector is divided into blocks of either 1×180 or 1×46, depending on whether it is required to represent whole the azimuth angles at a certain elevation, or represent the elevation angles at a certain azimuth. With such data, the mapping to 1D azimuth only information is very similar to that described above.

Another alternative to using 2D angular information in matrix format is to use some form of covariance representation for measuring the spread of the estimated area. Then, instead of giving the full 2D matrix as azimuth/elevation description of the angular location, the coordinate of the maximum of the distribution area and some parameters can be used to describe the distribution fully. In the example of a distribution in the shape of a ellipse, these parameters could be the lengths of the semi-axes and the rotation angle. This approach allows overlapping distributions, and also allows non-overlapping distributions, e.g. caused by multipath signals, to be defined easily. Each area of distribution is defined by a respective set of parameters. With distributions defined in this way, once the elevation has exceeded the threshold, mapping from 2D to 1D is performed in the angular domain, i.e without prior transformation to X,Y coordinates. In order to achieve this mapping, all that is needed is knowledge of the azimuth direction (or directions, if there are signal reflections) and the azimuth spread.

In some alternative embodiments, the threshold used in step S4 may be dependent on the azimuth angle provided by step S3. In this way, settings can be optimised for a given indoor environment. For instance, from a base station 30, an external wall may impose a limit on the possible locations of mobile devices 10 on floors above the ground floor.

Here, an azimuth and elevation vector combination that places the mobile device 10 outside of the exterior wall would indicate an incorrect location measurement. By providing thresholds that are dependent on the azimuth vector, locations that place the mobile device 10 incorrectly outside of the exterior wall can be detected. These are determined not to have met the elevation reliability criterion in step S4.

It will be appreciated that the above scheme is applicable also where the antenna array 32 is used in transmit mode instead of receive mode. Here, processing is performed at the mobile device such that the mobile device 10 calculates a bearing to the mobile device from the base station 30. In this case, the process is the same as described above, although step S2 involves recording data received from a single antenna element at the mobile device 10 instead of recording data from an antenna array. Of course, this is derived from an antenna array since it is multiple elements of an array at the base station 30 that transmitted the signal received at the mobile device 10.

In some embodiments, the base station 30 is configured to alternate between transmit and receive modes. In this case, the modes may be switched between on a time-division basis. This can allow the same base station 30 to be used to provide positioning beacons to mobile devices and to receive positioning beacons from mobile devices.

It will be appreciated also that the various processing steps described above can be performed at the base station 30, at a central server 58, which may be integrated with a base station, at a mobile device 10 or by any other suitable device.

The processing steps may be performed at locations distributed over the system. For instance, steps S1 to S5 may be performed at the base station 30 and steps S7 to S10 could be performed at the server 58. In this case, the reduction of the 2D angular estimation data to 1D data results in less data being transmitted from the base station 30 to the server 58, although if the elevation estimation is reliable then all of the data is transmitted to the server 58 for use in calculating the location of the mobile terminal.

The use to which location information is put after it is computed is outside the scope of this specification.

The components described above as forming part of the FPGA 537 can be implemented instead using another suitable technology. For instance, the apparatus may be implemented as one or more application specific integrated circuits. Further alternatively, the apparatus may be implemented as a combination of application specific integrated circuits and FPGAs. The apparatus may be implemented wholly or in part using a suitably programmed general purpose processor or a signal processor.

In other implementations, the components described above as forming part of the FPGA 537 may be implemented in software and executed by processing means, such as the processor 32 of FIG. 3. Here, all of the functionality provided by the FPGA 537 may be provided by the controller 31.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialised circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed function device, gate array or programmable logic device etc.

It will be appreciated that the above described embodiments are purely illustrative and are not limiting on the scope of the invention. Other variations and modifications will be apparent to persons skilled in the art upon reading the present application.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

1-26. (canceled)

27. A method comprising:
receiving data derived from a multi-element antenna direction finding arrangement;
processing the received data to provide elevation and azimuth vector data;
determining whether the elevation data meets a reliability criterion;
on a positive determination:
using the elevation and azimuth data to calculate a location; and
on a negative determination:
processing the data to provide one-dimensional azimuth vector data; and
using the one-dimensional azimuth vector data in conjunction with other vector data to calculate a location.

28. A method as claimed in claim 27, wherein the other vector data is derived from a second multi-element antenna direction finding arrangement.

29. A method as claimed in claim 27, wherein the other vector data is data previously derived from the first multi-element antenna direction finding arrangement.

30. A method as claimed in claim 27, wherein processing the data to provide one-dimensional azimuth vector data comprises mapping a two-dimensional estimate to a one-dimensional estimate.

31. A method as claimed in claim 27, wherein processing the data to provide one-dimensional azimuth vector data comprises summing data in each row of a two-dimensional data matrix.

32. A method as claimed in claim 31, comprising normalising the summed data, wherein the received data is derived from a multi-element antenna direction finding arrangement.

33. A method as claimed in claim 31, comprising mapping vector data to Cartesian data prior to calculating a location.

34. A method as claimed in claim 31, wherein determining whether the elevation data meets a reliability criterion comprises comparing the elevation vector data to a threshold.

35. A method as claimed in claim 34, wherein the threshold is dependent on the azimuth vector data corresponding to the elevation vector data.

36. A method as claimed in claim 31 wherein receiving data derived from a multi-element antenna direction finding arrangement comprises receiving data derived from signals transmitted by multiple elements of a multi-element antenna arrangement and received at a single element antenna arrangement.

37. A computer program comprising machine readable code that when executed by computing apparatus controls it to perform the method of claim 27.

38. Apparatus comprising:
a receiver configured to receive data derived from a multi-element antenna direction finding arrangement;
a processor configured to process the received data to provide elevation and azimuth vector data;
a processor configured to determine whether the elevation data meets a reliability criterion;
a processor configured to respond to a positive determination by using the elevation and azimuth data to calculate a location; and
a processor configured to respond to a negative determination by processing the data to provide one-dimensional azimuth vector data; and
a processor configured to use the one-dimensional azimuth vector data in conjunction with other vector data to calculate a location.

39. Apparatus as claimed in claim 38, wherein at least one of the following;
A) the processors configured to process the received data to provide elevation and azimuth vector data is co-located with the means for calculating a location or
B) the other vector data is derived from a second multi-element antenna direction finding arrangement or
C) the other vector data is data previously derived from the first multi-element antenna direction finding arrangement.

40. Apparatus as claimed in claim 38, wherein the processor configured to process the data to provide one-dimensional azimuth vector data is further configured to map a two-dimensional estimate to a one-dimensional estimate.

41. Apparatus as claimed in claim 38, wherein the processor configured to process the data to provide one-dimensional azimuth vector data is further configured to sum data in each row of a two-dimensional data matrix.

42. Apparatus as claimed in claim 41, further comprising a processor configured to normalize the summed data.

43. Apparatus as claimed in claim 41, further comprising a processor configured to map vector data to Cartesian data prior to calculating a location.

44. Apparatus as claimed in claim 41, wherein the processor configured to determine whether the elevation data meets a reliability criterion is further configured to compare the elevation vector data to a threshold.

45. Apparatus as claimed in claim 44, wherein the threshold is set depending on the azimuth vector data corresponding to the elevation vector data.

46. A computer tangible readable medium having stored thereon machine readable instructions that when executed control it to perform:
receiving data derived from a multi-element antenna direction finding arrangement;
processing the received data to provide elevation and azimuth vector data;
determining whether the elevation data meets a reliability criterion;
on a positive determination:
using the elevation and azimuth data to calculate a location; and
on a negative determination:
processing the data to provide one-dimensional azimuth vector data; and
using the one-dimensional azimuth vector data in conjunction with other vector data to calculate a location.

47. Apparatus comprising:
one or more processors in communication with one or more memories, the one or memories having stored therein one or more computer programs that include computer code configured such as when executed to cause the processor to:
receive data derived from a multi-element antenna direction finding arrangement;
process the received data to provide elevation and azimuth vector data;
determine whether the elevation data meets a reliability criterion;
on a positive determination:
use the elevation and azimuth data to calculate a location; and
on a negative determination:
process the data to provide one-dimensional azimuth vector data; and
use the one-dimensional azimuth vector data in conjunction with other vector data to calculate a location.
